(19) United States
(12) Patent Application Publication
(10) Pub. No.: US 2007/0232294 A1
(43) Pub. Date: Oct. 4, 2007

(54) Silent redial method in a wireless communication system

(76) Inventor: William E. Welnick, Poway, CA (US)

Correspondence Address: MOTOROLA INC, 600 NORTH US HIGHWAY 45, ROOM AS437, LIBERTYVILLE, IL, 60048-5343, US

(21) Appl. No.: 11/391,529

(22) Filed: Mar. 28, 2006

(51) Int. Cl. H04Q 7/20

(52) U.S. Cl. 455/426.1

(57) ABSTRACT

A method in a wireless communication device for silent redial comprising attempting to access a new system in response to a failed access attempt with a first system. The method includes determining (124) that the new system is not in the same GEO group as the first system. Receiving (126) the new system MCC/MNC and determining (130) that the new MCC/MNC is included on a home MCC/MNC list and then sending (132) an access probe sequence to the new system.

### FIELD OF THE DISCLOSURE

The present disclosure relates generally to wireless communications and more particularly to silent redialing methods.

### BACKGROUND OF THE DISCLOSURE

Some wireless communication systems have a list of other communications systems the mobile station may access or “roam” to, generally called a preferred roaming list (PRL). The PRL stores a list of systems the mobile may access in an indexed order, each system identified by the system identification (SID) and the network identification code (NID). An enhanced PRL has been recently adopted by some systems. The Enhance PRL feature requires the network to broadcast a mobile country code (MCC) and a mobile network code (MNC) code on networks to be active and accurate. These MNC/MCC codes give accurate information as to the identity of the network operator. Each operator only has a small number on MNC/MCC codes for their entire network. Encoding the MCC/MNC in the PRL reduces the number of entries in the PRL needed to describe a network.

In these wireless communication systems, it is desirable to have the capability for a mobile station to silently redial a number until a connection is established. Silently redialing the number is known wherein the wireless communication device repeatedly dials a number without indication to the user.

A geographical group (a.k.a. geo group) which is also a part of the PRL, lists systems, in preferential order, that are available to a mobile station within a given geographic area. There exists system requirements however which limit silent redial attempts to systems within the current GEO group, and even further, the same or higher priority systems within that current GEO group. This is to prevent mobiles from roaming to other systems which results in the incurrence of roaming charges. However, if origination of a call starts on a first system in one GEO group the mobile cannot silent redial to a second system in another GEO group. For example, when a customer starts his call origination on a boundary between two different systems, reflected by two different GEO groups, the mobile travels from a system in one GEO group to a system in a different GEO group and the call will fail. Additionally if the call origination starts on a roam system the call will be prevented from going through on a home system in another GEO group which should be preferred.

The various aspects, features and advantages of the present disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

The present invention is illustrated by way of example and not limitation in the accompanying figures, in which like references indicate similar elements.

FIG. 1 is an illustrative wireless communication system.

FIG. 2 is an illustrative roaming list.

FIG. 3 is an illustrative silent redial flow diagram.

FIG. 4 is an illustrative silent redial flow diagram.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

In general, a wireless communication system 100 comprises a plurality of base transceiver stations 102/104 providing wireless communication service, including voice and/or data service, to wireless terminals 106 over corresponding regions or cellular areas. The wireless terminals may be referred to as wireless communications devices, mobile stations, mobiles, user equipment, handheld, mobile unit or the like. The base transceiver stations, also referred to by other names such as base station, a “Node B” or the like depending on the system type, are communicably coupled to a controller and to other entities and well known by those having ordinary skill in the art. The base station is part of a radio access network portion of the one wireless communication system. Exemplary communication systems include, but are not limited to, Code Division Multiple Access System (CDMA) network, developing Universal Mobile Telecommunications System (UMTS) networks, Evolved Universal Terrestrial Radio Access (E-UTRA) networks, and other OFDM based networks.

Before describing in detail embodiments that are in accordance with the present invention, it should be observed that the present invention resides primarily in combinations of method steps and apparatus components related to the communication device, communication node, and method for silent redial. Accordingly, the apparatus components and method steps have been represented where appropriate by conventional symbols in the drawings, showing only those specific details that are pertinent to understanding the present invention, so as not to obscure the disclosure with details that will be readily apparent to those of ordinary skill in the art, having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

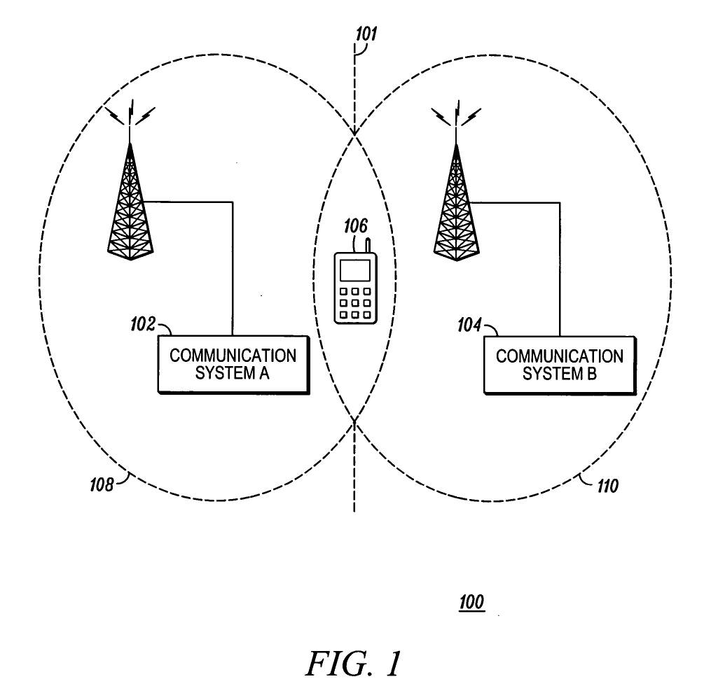

FIG. 1 is an illustrative wireless communication network 100 comprising a first wireless communication system 102 and a second communication system 104. A mobile station 106 is shown and may connect to the first system 102 and the second system 104 or any other available systems not shown in the illustrative diagram of FIG. 1. Only two systems are shown for simplicity sake. In this embodiment, the mobile station 106 is on the boarder between the first system 102 and the second system 104 which is referred to as a geographical boundary 101 of the wireless communication network 100. The geographical boundary 101 is a boundary between multiple systems that may be operated by a single service provider or may be systems operated by multiple service providers. Each system has system identification code (SID). For example, one SID may cover a city area. Larger cities may have two or three SID to identify different systems within the city. Each system may have subgroups identified by a network identification code (NID). A NID may identify different MSC boundaries, rating areas, toll area, private network or the like within a network identified by a SID.

In this embodiment, the first system 102 is in a first geographical area (first GEO) 108 and the second system 104 is in a second geographical area (second GEO) 110. A geographical area generally includes a plurality of systems identified by a plurality of SIDs. For example, the western United States may be defined as one geographical area. In another example, the southern portion of a state may be a geographical area. In each of these examples the geographical area includes a plurality of systems.

In one embodiment, the first system 102 is a home system in the first geographical area for the mobile station 106 and is identified by a first SID. A home system refers to a system that the service provider considers to be the primary system. The second system 104 is a home system in the second geographical area for the mobile station 106 and is identified by a second SID. In another embodiment, the first system 102 is a roam system in the first GEO group for the mobile station 106 and the second system 104 is a home system in the second GEO group for the mobile station 106. In another embodiment, the first system 102 is a roam system in the first GEO group for the mobile station 106 and the second system 104 is a roam system in the second GEO group of same or high priority than the first system 102, for the mobile 106.

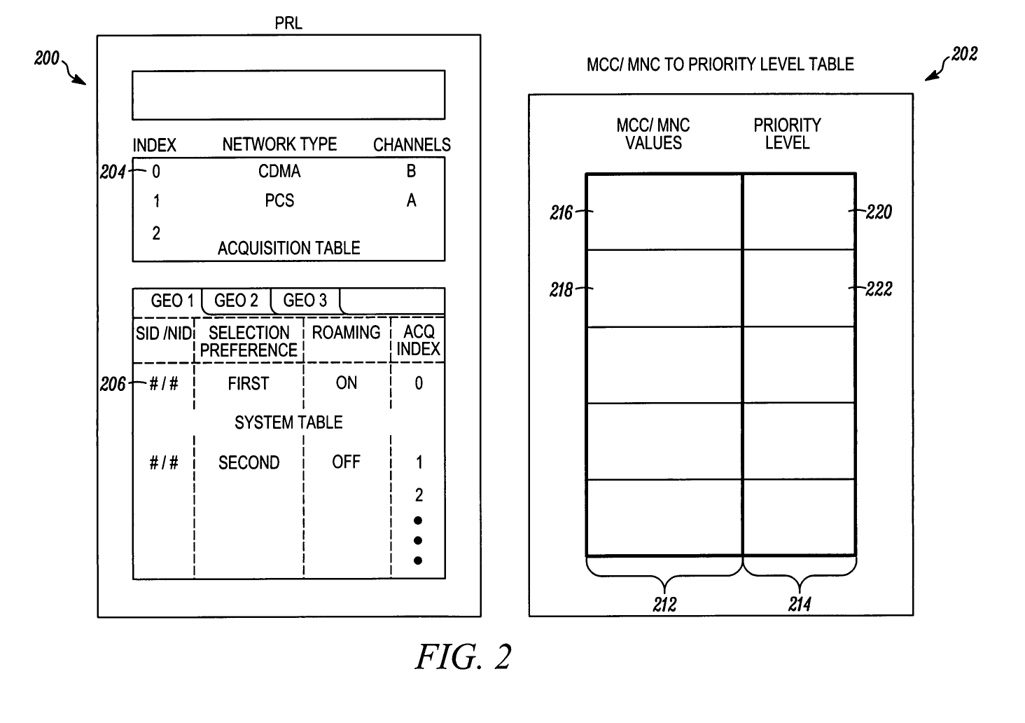

FIG. 2 is an illustrative preferred roaming list (PRL) 200 having at least an acquisition table 204 and a system table 206. The system table 206 includes a plurality of GEO groups 208 which is a list of permitted or preferred systems and corresponds to each geographical area (GEO). The service provider defines the entire PRL. The service provider determines which systems should be preferred for each GEO and assigns the preferred system in a preferential order in the GEO group list. For example, GEO1, GEO 2 and GEO 3 are shown in this exemplary embodiment. In each GEO group 208 (i.e. GEO 1, GEO 2, . . . ), at least one system is listed as a most preferred system for which the mobile 106 may attempt to acquire and connect with. Systems that are found to be the most preferred within a GEO group are not necessarily home systems. In certain geographic areas there may be no home systems for the mobile to acquire however other services may be available to the mobile user.

System acquisition is known to those of ordinary skill in the art and the acquisition process may vary from system to system, or system operator to system operator. During the system acquisition process, the mobile 106 may receive the SID, and the NID. In one embodiment, the SID and NID are sent in a sync channel message and may also be transmitted on overhead paging messages.

The mobile may also receive the Mobile country code (MCC) and the Mobile network code (MNC) or the like. The MCC and the MNC are broadcast generally on a broadcast channel. The MCC identifies the country of the system. The MNC identifies the network. For example, the MNC may be assigned to systems which include all of Western United States or the Midwest. Incorporating the MCC/MNC pair into the PRL 200 effectively shortens the PRL list, particularly for service providers with large service areas. As per the CDMA standard in one embodiment, the MCC and it the MNC are broadcast in over head messages by each base station to the mobile 106.

The preferred system for acquisition and connection may be a home system or a roam system. The mobile station 106 determines which GEO it is currently located in, and a current GEO list 210, by information sent to the mobile from the current serving cell i.e. base station. The mobile 106 matches the SID/NID information broadcast by the base station to the SID/NID information in the PRL 200. The GEO group is determined by the best match within the PRL 200. If the enhanced PRL feature is in use, then the MCC/MNC codes broadcast by the network are matched to encoded MCC/MNC values in the PRL 200. During silent redial, the mobile 106 will check the current GEO list 210 when attempting to access other systems when the preferred system is unavailable or not responding to system acquisition attempts by the mobile 106.

FIG. 2 also shows an illustrative MCC/MNC priority level table 202. In this embodiment, the MCC/MNC priority level table 202 is not apart of the PRL 200. The MCC/MNC priority level table 202 includes a list of MCC/MNC values 212 and corresponding priority levels 214 for each MCC/MNC in the list. The MCC/MNC values 212 are mapped to and may be used to determine the priority level of a first system 102 and a second system 104 based on the priority level 214 of the first system MCC/MNC value and a priority level of the second system MCC/MNC value. In this embodiment a first priority level 220 of a first MCC/MNC value 216 is compared to a second priority level 222 of a second MCC/MNC value 218. In this embodiment, the priority for systems 212 is determined by the corresponding priority level table entry 214. For example the priority level for the first MCC/MNC value 216 is 220, and the priority level for the second MCC/MNC value 218 is 222. It is understood to those of ordinary skill in the art that the priority may be indicated in a plurality of methods and the illustrative embodiment is not intending to be limited to this one example.

In one embodiment, encoded MCC/MNC values may be present in both the PRL 200 and the MCC/MNC priority level table 202. In another embodiment the encoded MCC/MNC values may be present only in the MCC/MNC priority level table 202. The presence of the MCC/MNC values in either the PRL or the MCC/MNC priority level table 202 may vary over time. In one embodiment the MCC/MNC priority level table 202 may include a home system indication for every entry in the table 202. The device 106 refers to the MCC/MNC values 212 of the MCC/MNC priority level table 202 to determine that the second system is a home system. Additionally when the first system 102 is a known home system as determined using SID/NID values and not MCC/MNC values, the table 202 is only used to determine if the second system 104 is a home system.

In one embodiment, the MCC/MNC values of the first system, for example, are used to record the priority level 214 of the first system 102. The MCC/MNC values are mapped to a priority level and maintained in the MCC/MNC priority level table 202.

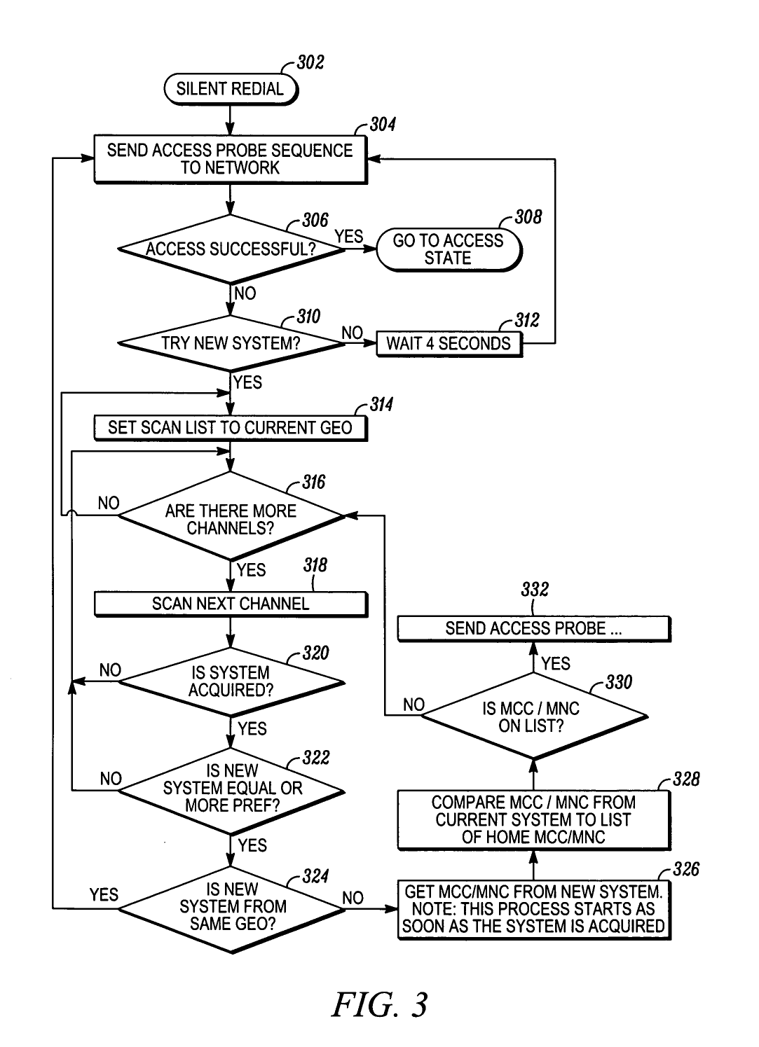

FIG. 3 is an illustrative flow diagram of one embodiment of a silent redial method in a mobile station 106. In this embodiment, the mobile station 106 starts the silent redial 302 process. It is understood that a plurality of events may initiate the silent redial process. In this embodiment, silent redial is used by the mobile to improve the success rate of the access to the network and enable the mobile to discriminate a roam system from a home system and prevent unknown roaming charges to the mobile user. In another embodiment, the mobile determines that a geographical area in which the mobile is positioned has changed and the second system needs to be verified since it's in a new GEO group and may not be a home system. In this embodiment, the mobile station sends 304 an access probe sequence to a first system 102, that the mobile is currently monitoring, in an attempt to access system 102.

The mobile determines 306 if the access probe is successful. Methods for determining whether the access probe is successful are understood to those of ordinary skill in the art. If the access probe is successful, then the mobile goes to active state 308 and continues with the call. If the mobile determines 306 that the access probe is not successful, the mobile then determines 310 if it should try a second system. In one embodiment, the mobile will attempt to access the system a predetermined number of times before it attempts to try a new system. If the mobile 106 determines not to try a second system, the mobile waits for a predetermined period of time 312 and then sends 304 another access probe to the first system.

If the mobile determines 310 that it is to try a second system 104, the mobile sets 314 the scan list determined by the current GEO group. Once the scan list is set, the mobile 106 determines 316 if there are any more channels available. If there are no more channels available to scan for system acquisition, then the mobile 106 will continue with the other channels, the silent redial will time out or continue through the list of channels again until a system is acquired. If there are more channels available, then the mobile scans 318 the next channel in the list.

Once a second system is acquired 320, then the mobile determines 322 whether the new system has a preference level that is equal to or more preferred then the first system. If the second system's preference level is not equal or is less preferred, then the mobile 106 returns to the step of determining 316 if there are more channels to scan. If the second system 104 is equal to or more preferred than the first system 102, then the mobile determines 324 if the second system 104 is a part of the same GEO group as the first system 102. If the second system 104 is not from the same GEO group, then the mobile refers to the MCC/MNC received from the second system 104 after acquisition. In this embodiment, the mobile 106 has received the MCC/MNC from the second system 104 while monitoring the over head messages 326. The mobile determines 328 and 330 if the second system MCC/MNC of the second system 104 is on the MCC/MNC priority level table 202. In one embodiment this is referred to as a home MCC/MNC list. If the second system MCC/MNC is on the home MCC/MNC list, then the mobile sends 332 an access probe to the second system 104. If the second system MCCC/MNC is not on the home MCC/MNC list, then the mobile 106 may check 316 for more channels within the current scan list to see if there is another system to attempt to acquire for the silent redial.

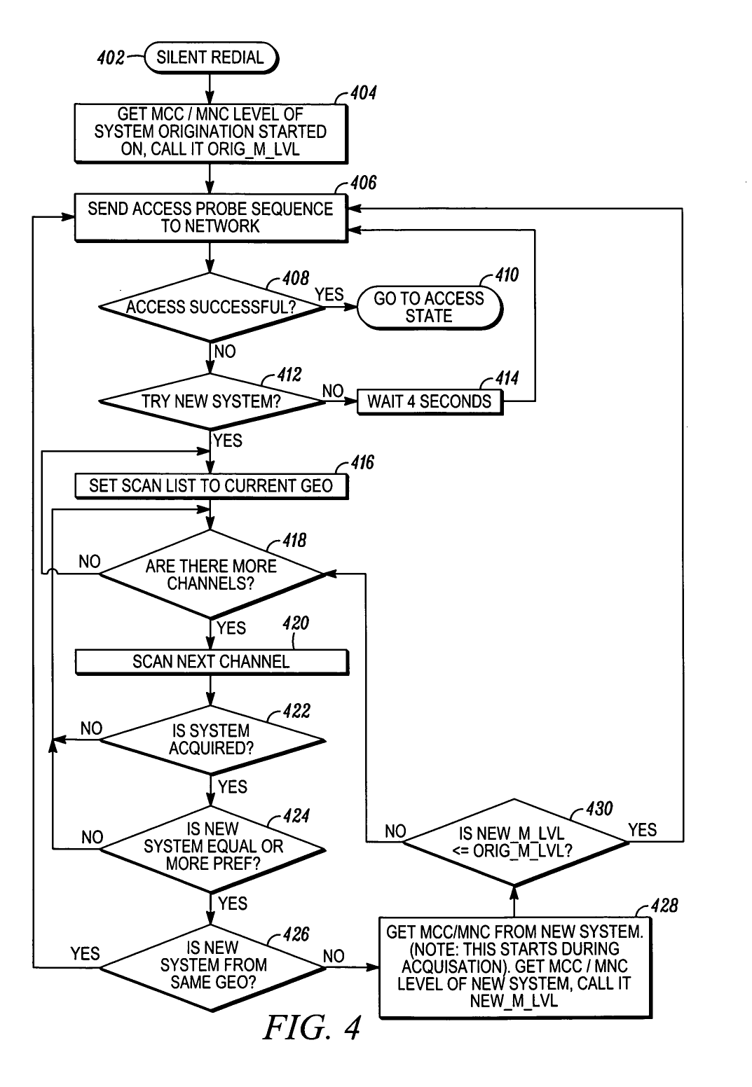

FIG. 4 is an illustrative flow diagram for one embodiment for silent redial method. In this embodiment, after the mobile begins 402 the silent redial process, the mobile compares, 404 the mobile country code (MCC) and the mobile network code (MNC) for the system where the call origination began to a table with the MCC, MNC and a MCC/MNC level value In this embodiment, the MCC/MNC level is called ORIG_M_LVL. Once the mobile records ORIG_M_LVL, it sends 406 an access probe sequence to the first system 102.

The mobile 106 determines 408 if the access probe is successful. If the access probe is successful, then the mobile 106 goes to active state 410 and continues with the call as discussed above. If the mobile 106 determines 408 that the access probe is not successful, the mobile 106 then determines 412 if it should try a second system 104. If the mobile determines not to try a second system just yet, the mobile waits 414 for a predetermined period of time and then sends 406 another access probe to the first system 102. The mobile 106 may try the current system a predetermined number of times before it attempts to access another new system.

If the mobile 106 determines that it is to try a second system 104, the mobile sets 416 the scan list to the current GEO group. Once the scan list is set, the mobile 106 determines 418 if there are any more channels available. If there are no more channels available to scan for system acquisition, then the mobile refreshes the scan list 416 and continues scanning channels. As discussed above, the silent redial period may time out or there may be more time to continue scanning for a second system. If there are more channels available, then the mobile 106 scans 420 the next channel.

Once a second system is acquired 422, then the mobile determines 424 whether the new system has a preference level (also known as priority level) that is equal to or more preferred then the first system. If the second systems has a preference level that is not equal to or is less preferred than the first system, then the mobile 106 returns to determine 418 if there are more channels to scan. If the second system 104 is equal to or more preferred than the first system, then the mobile 106 determines 426 if the second system 104 is a part of the same GEO group as the first system 102. If the second system 104 is not from the same GEO group, then the mobile monitors the second system 104 to receive the MCC/MNC values of the second system 102 unless it already has them. The mobile 106 will record or store the second system MCC/MNC values in a memory of the device or a memory coupled thereto. The mobile 106 compares the received MCC/MNC values to the MCC/MNC values 212 in the MCC/MNC priority level table 202 to determine the MCC/MNC priority level 214 of the second system. In this embodiment, the MCC/MNC priority level 214 of the second system is referred to as NEW_M_LVL 428. The mobile 106 then determines 430 whether the second system MCC/MNC value is less than or equal to the originating MCC/MNC level, by comparing NEW_M_LVL to the previously recorded ORIG_M_LVL. If the second system MCC/MNC is less than or equal to the originating MCC/MNC, then the mobile 106 sends an access probe sequence 406 to the second system 104.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication device for silent redial, the method comprising:
attempting to acquire a second system in response to a failed access attempt with a first system;
determining that the second system is not in the same geographical group as the first system;
determining that a second MCC/MNC of the second system is included in a MCC/MNC priority level table; and
sending an access probe sequence to the second system.

2. The method of claim 1, receiving, after the second system is acquired, the MCC/MNC values of the second system.

3. The method of claim 2, determining from the received MCC/MNC values that the second system is a home system.

4. The method of claim 3, using the MCC/MNC priority level table to determine that the second system is a home system.

5. The method of claim 1, determining that a geographical area in which the device is positioned has changed and needs verification.

6. The method of claim 1, wherein the first system is a first home system in a first geographical area and the second system is a second home system in a second geographical area.

7. A method in a wireless communication device for silent redial, the method comprising:
storing the Mobile Network Code (MCC) and Mobile Country Code (MNC) of a first system;
attempting to acquire a second system in response to a failed access attempt with a first system acquisition;
determining that the second system is not in the same geographical group as the first system;
receiving a second MCC/MNC of the second system and determining that the second MCC/MNC of the second system has a priority level that is equal to or greater than a priority level of the stored first system MCC/MNC; and
sending an access probe to the second system.

8. The method of claim 7, wherein the MCC/MNC values of the first system are used to record a priority level.

9. The method of claim 7, wherein MCC/MNC values are mapped to a priority level and maintained in a priority level table.

10. The method of claim 7, wherein MCC/MNC values for the second system are used to determine a second system priority level

11. The method of claim 7, wherein a priority level of the first system is compared to a priority level of the second system to determine if the second system has a priority equal to or greater than the first system.

12. The method of claim 7, determining the geographical group by information received during system acquisition.

13. The method of claim 7, determining the geographical group by the best match within a PRL.

14. The method of claim 7, sending an access probe to the second system in response to determining that the second MCC/MNC of the second system has a priority level that is equal to or greater than a priority level of the stored first system MCC/MNC.

15. A method for silent redial in a wireless communication system comprising:
initiating a silent redial by attempting to access a first system, the first system included in a first geographical group;
determining that the access attempt on the first system failed;
attempting to access a second system; and
determining that the second system is included in a second geographical group, different from the first geographical group; and
determining that the second geographical group is included in a home geographical group.
